(19) United States
(12) Patent Application Publication
(10) Pub. No.: US 2012/0303290 A1
(43) Pub. Date: Nov. 29, 2012

(54) REALTIME SILICON DETECTION SYSTEM AND METHOD FOR THE PROTECTION OF MACHINERY FROM SILOXANES

(75) Inventor: John Chrysostom Stasko, Everett, WA (US)

(73) Assignee: Applied Filter Technology, Inc.

(21) Appl. No.: 13/482,633

(22) Filed: May 29, 2012

Related U.S. Application Data
(60) Provisional application No. 61/491,137, filed on May 27, 2011.

(51) Int. Cl. G06F 19/00

(52) U.S. Cl. 702/24

(57) ABSTRACT

An inline siloxane detection system including each of an inductively coupled plasma (ICP) exciter; a beam splitter to split a light beam emitted from the ICP exciter into secondary light beams; a first signal filter selectively configured for a wavelength corresponding to silicon and configured to receive a first secondary light beam from the beam splitter; a first detector configured to detect a silicon-indicating wavelength in the first secondary light beam; a second signal filter configured to receive second secondary light beam from the beam splitter, and further selectively configured for a background wavelength of the second secondary light beam; a second detector configured to receive and detect a filtered signal from the second signal filter; and a processor configured to receive signals from each of the first detector and the second detector and to calculate a concentration of silicon in the gas sample.

### RELATED APPLICATIONS

This application claims the benefit of priority to U.S. Provisional application No. 61/491,137, filed on May 27, 2011 and entitled A REALTIME SILICON DETECTION SYSTEM FOR THE PROTECTION OF MACHINERY FROM SILOXANES, the contents of which are hereby incorporated herein in their entirety by this reference.

### FIELD OF THE INVENTION

The invention relates generally to the field of composition analysis of gases, and more particularly to analysis of biogas for the presence of organosilicates including siloxane.

### BACKGROUND OF THE INVENTION

Siloxanes (organosilicates) are significantly present in biogas and hamper their use (Raf Dewil et al., Energy use of biogas hampered by the presence of siloxanes; Energy Conversion and Management, 47(13-14):1711-1722, 2006). Removal of these siloxanes is a costly enterprise yet enables biogas utilization and energy production. On-line detection of siloxanes to acceptable levels is important to evaluate gas before it damages equipment. However, such detection is hampered by current technology, which employs gas chromatography and typically mass spectroscopy or infrared absorption spectrometry. Gas chromatography is known to require frequent calibration because of inherent drift, and is therefore not acceptable due to expense. Other technology such as Rahman scattering has not yielded promising results. However, the ultimate reason for on-line detection is the provision of protection of machinery and hardware.

A search of “siloxane detection online” demonstrates only one device offered by the company called Photovac, Inc., located in Waltham, Mass. However, a careful study of their technology, which is photoionization after gas chromatography, demonstrates that their advertised detection limit of 5 parts per billion (ppb) can only be achieved in the laboratory, not in the field. This is because biogas is a complex mixture of confounding substances which cannot be differentiated by gas chromatography alone. As a result, we believe this device may over-report the amount of siloxanes in the gas. This is problematic for companies that sell media to clean siloxanes, since it means that media would be falsely portrayed as underperforming by their device. Moreover, it requires a gas chromatography column which requires frequent calibration. Therefore, they have not adequately solved the problem of siloxane detection.

MKS Instruments, Inc., located in Andover, Mass., were also unable to produce the required detection limit after several years of development.

Agilent Technologies, located in Santa Clara, Calif., offers the typical solution for siloxane detection, that is, gas chromatography-inductively coupled plasma mass spectrometry (GC-ICP-MS). However, their solution is expensive since it attempts to speciate siloxanes, and is not designed for continuous, on-line use. Furthermore, it employs a gas chromatography column which requires frequent calibration. Their solution is quite unsuitable for on-line detection.

### BRIEF DESCRIPTION OF THE DRAWINGS

FIG. 1 depicts a silicon detection system according to an exemplary embodiment of the invention.

### DETAILED DESCRIPTION OF THE PREFERRED EMBODIMENTS

Using available technology, that is, inductively coupled plasma (ICP) and subsequent wavelength detection, it is possible to design a device which is to be placed either at the gas stream before the critical equipment, or after the critical equipment, to detect only the presence of the silicon atom itself. Such a system would be usable where calcium silicates are readily removed by an upstream process such as after a carbon media bed. Therefore, only volatile organic silicates would remain in the gas stream.

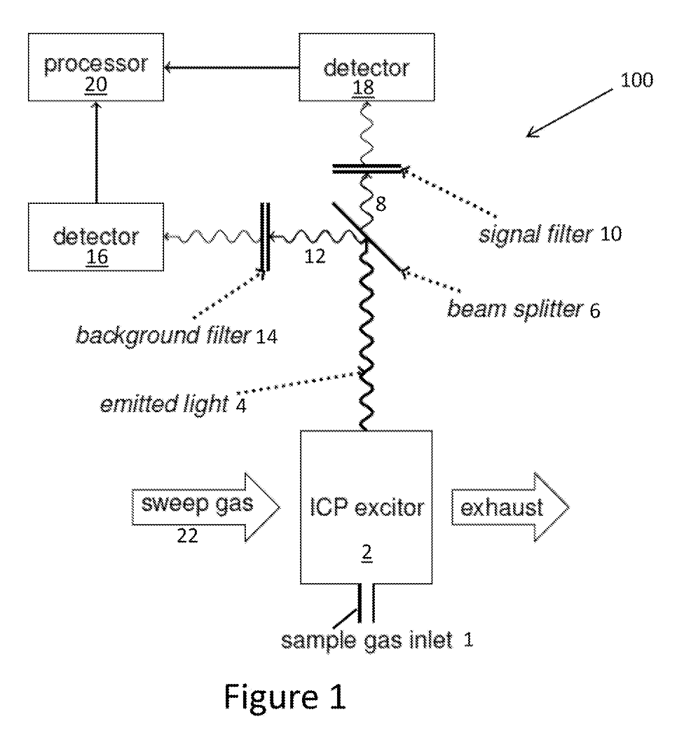

A typical example of such a device is depicted in FIG. 1. The sample gas enters the apparatus 100 at an inlet 1. In this example, an ICP exciter 2 is used, where the sample gas is excited as a plasma, thereby emitting light 4. The rendered light 4 then passes to a beam splitter 6. One of the beams 8 passes to a signal filter 10, which is set to a strong wavelength of silicon, typically 288.15 nanometers (nm). The transmitted light is then detected. Similarly, the other beam 12 passes through a background filter 14, to select a background wavelength. This light is also detected. The two simple detectors 16/18, such as photodiodes or photomultiplier tubes (PMTs), transmit signals to the processor 20, which calculates the resultant concentration, consequently transmitting this result to the user or to other plant hardware. The invented system and method are capable to detect silicon to a level below parts per billion in a gas sample, in real-time and in-line as described.

The advantage to using these technologies is that they can be performed in an open chamber that will not be continuously fouled with silicon dioxide, which is rendered upon burning the organosilicates. A stream of gas (e.g., sweep gas) 22, such as argon or air, can be used to protect the light filtering and detection components of the apparatus by sweeping any resulting compounds out of the chamber containing these components.

The price of this apparatus is kept low by detecting only the silicon peak as well as a neighboring background wavelength. Measuring the full spectrum is not necessary since only the detection of silicon is important to protect equipment. A typical silicon peak would be 288.15 nm.

A filter such as an interference filter (available from Deposition Research Lab Inc., located in Saint Charles, Mo.) using transmission (depicted) or reflection could be used to select the wavelengths. A detector such as a photomultiplier tube or photodiode detects the photon. A digital or analog processor would count the photons, perform background subtraction, and render the result on a display or transmit the result using other technology such as Modbus or 20 milliAmp (mA) current loop to communicate with other data acquisition devices or plant hardware.

This apparatus may detect to a level measured in parts per trillion the amount of silicon in the continuously sampled gas, and thereby protect equipment and assist in scheduling media maintenance, in a device requiring low maintenance and at a low capital expense.

Much work has been done for such a long time to find a solution to stated problems, yet so many customers still require an accurate solution. Therefore, we believe the solution described herein is not obvious to those having skill in the applicable art.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention. Those of skill in the art will appreciate that the method system and apparatus are implemented in a combination of the three, for purposes of low cost and flexibility.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

We claim:

1. An inline silicon detection system, comprising:
an inductively coupled plasma (ICP) exciter including a sample gas inlet, and configured to excite a gas sample and to emit a primary light beam indicative of at least one constitute of the gas sample;
a beam splitter configured to receive a primary light beam emitted from the ICP exciter and to split the light beam into at least a first and a Second Secondary light beams;
a first signal filter configured to receive the first secondary light beam from the beam splitter, and further selectively configured for a wavelength corresponding to silicon;
a first detector configured to receive and detect a filtered signal from the first signal filter;
a second signal filter configured to receive the second secondary light beam from the beam splitter, and further selectively configured for a background wavelength of the second secondary light beam;
a second detector configured to receive and detect a filtered signal from the second signal filter; and
a processor configured to receive signals from each of the first detector and the second detector, and further configured to calculate a concentration of silicon in the gas sample.

2. The inline silicon detection system of claim 1, wherein:
the ICP exciter is coupled with a gas supply line upstream from a gas supply port of a machine; and
the gas inlet of the ICP exciter is configured to admit a gas sample from the gas supply line into the ICP exciter.

3. The inline silicon detection system of claim 1, wherein the ICP exciter is coupled with a gas line downstream from an exhaust port from a machine.

4. The inline silicon detection system of claim 1, wherein the first signal filter is set to a wavelength of 288.15 nanometers.

5. The inline silicon detection system of claim 1, wherein one or both of the first detector and the second detector comprises either of a photodiode or a photomultiplier tube.

6. The inline silicon detection system of claim 1, wherein one or of the first signal filter and the second signal filter comprises either of a transmission filter or a reflection filter.

7. The inline silicon detection system of claim 1, further comprising:
a display device coupled with the processor and configured to visibly display a result of the calculation.

8. The inline silicon detection system of claim 1, further comprising:
a device configured to remove calcium silicates from a gas flowing either into or though the gas supply line, wherein the calcium silicates removal device is disposed upstream from the ICP exciter.

9. The inline siloxane detection system claim 8, wherein the calcium silicates removal device is a carbon media bed.

10. An inline silicon detection method, comprising:
diverting into an inductively coupled plasma (ICP) exciter a sample of a gas from one of a gas supply line upstream from a machine inlet port and a gas exhaust line downstream from a gas exhaust port;
causing the ICP exciter to excite the gas sample, to form a plasma therefrom, and to cause the plasma to emit a primary light beam indicative of at least one constitute of the gas sample;
splitting the primary light beam, via a beam splitter, into a first secondary light beam and a second secondary light beam;
filtering, via a first signal filter, the first secondary light beam selectively for a wavelength indicative of silicon;
producing, via a first detector, a first detector signal indicative of either of a presence or absence of a silicon-indicating wavelength in the filtered secondary light beam;
filtering, via a second signal filter, the second secondary light beam selectively for a background wavelength;
producing, via a first detector, a second detector signal indicative of the background wavelength;
processing each of the first detector signal and second detector signal; and
calculating a concentration of silicon in the gas sample.

11. The inline silicon detection method of claim 10, wherein the filtering the first secondary light beam selectively for a wavelength indicative of silicon comprises passing the first secondary light beam through a first signal filter configured selectively for a wavelength of 288.15 nanometers.

12. The inline silicon detection method of claim 10, wherein the producing a first detector signal indicative of a presence or absence of a silicon-indicating wavelength comprises analyzing the filtered first secondary light beam via a first detector comprising either of a photodiode or a photomultiplier tube.

13. The inline silicon detection method of claim 11, wherein the first signal filter comprises either of a transmission filter or a reflection filter.

14. The inline silicon detection method of claim 10, further comprising:
visibly displaying a result of the calculation at a display device.

15. The inline silicon detection method of claim 10, further comprising:
removing, upstream from the ICP exciter, calcium silicates from the gas being sampled.

16. The inline silicon detection system of claim 15, comprising:
removing the calcium silicates via a carbon media bed.

17. The inline silicon detection system of claim 15, comprising:
exposing any one of or combination of the first signal filter, the second signal filter, the first detector, and the second detector, to a flowing sweep gas; and
exhausting therefrom the sweep gas and also silicon dioxide produced by the combustion of organosilicates in the excited gas sample.
